(19) United States
(12) Patent Application Publication
(10) Pub. No.: US 2002/0007289 A1
(43) Pub. Date: Jan. 17, 2002

(54) Method and apparatus for processing automobile repair data and statistics

(76) Inventors: Mark Elliott Malin, Los Angeles, CA (US); Roni Dion Gill, Northridge, CA (US); Edwin Warren Hill, Los Angeles, CA (US); Edward C. Mohr, Camarillo, CA (US); Robert Taylor, Los Angeles, CA (US); Rick Beckett, Los Angeles, CA (US); Boris Vuchic, Madison, NJ (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/735,912

(22) Filed: Dec. 14, 2000

Related U.S. Application Data
(63) Continuation-in-part of application No. 09/614,147, filed on Jul. 11, 2000.

(51) Int. Cl. G06F 17/60

(52) U.S. Cl. 705/4; 705/9; 705/29

(57) ABSTRACT

A method coordinates automobile repairs and includes maintaining in a first database shop specific statistics for several body shops. The shop specific statistics are automatically updated based on repair data associated with individual automobile repair orders at each individual body shop. The method further includes receiving insurance claim data relating to the repair of an automobile and processing the shop specific statistics based on the insurance claim data to facilitate assigning an insurance claim associated with the insurance claim data to one of the plurality of body shops.

### FIELD OF THE INVENTION

The present invention relates generally to data processing and, more particularly, to providing a platform for processing automobile repairs which may collect automobile repair data and statistics, process insurance claims, schedule automobile repairs, exchange information among relevant parties and report on status and other aspects of automobile repairs.

### BACKGROUND OF THE INVENTION

The automobile repair industry, including the collision repair industry, is under continuous pressure from insurance companies to operate efficiently, with high levels of customer satisfaction and in ways which are compliant with guidelines, such as direct repair programs (DRPs). Historically, insurance companies have brought to bear this pressure by requiring automobile repair shops to purchase expensive computer systems and software packages. These systems include estimating systems, imaging and communications systems and after market parts location systems. Insurance companies have also required compliance with DRP program procedures, which has resulted in burdensome implementation, monitoring and re-inspection costs to both insurers and automobile repair shops. In addition to the above systems, shops frequently use management systems.

Estimating systems are used by estimators and administrative personnel to create estimates that describe and price the parts and labor required to repair automobiles. Each estimate includes several estimate tasks that collectively define the work to be performed at the macroscopic level. The estimating system applies standard time durations for performing the estimate tasks. The estimating system also deducts time from the estimate when multiple estimate tasks need to be performed and there is some overlap between tasks. The total cost or price of the estimate is what a repair shop may charge the insurance company for a repair and is based on parts and labor costs as determined by the total time in the estimate multiplied by an hourly billing rate for repair technicians. In this manner, insurance companies have gained some control over the pricing process and have reduced fraud. Estimating systems, however, are not designed to improve shop operations and consequently have had no substantial impact in this regard.

Management systems provide repair shops with additional ways to control costs. For example, management systems receive estimates, include tools to facilitate ordering parts specified in the estimates and facilitate tracking costs.

Despite improvements in control occasioned by estimating and management systems, there are still significant shortcomings in the operation of repair shops from the insurance company perspective. For example, there are many problems associated with an automobile repair shop's actually performing automobile repairs, based on an estimate, in a timely, accurate and appropriate manner. To illustrate the problem, consider an estimate that describes estimate tasks for repairing an automobile. Each of the estimate tasks describes work to be performed at the macroscopic level. At the microscopic level, each estimate task may require a repair shop to perform multiple repair tasks in the proper sequence. For example, consider the estimate task—replace left quarter panel—which appears within an estimate for repairing an automobile with rear-end damage. This estimate task requires multiple repair tasks to be performed including: ordering a new quarter panel, removing glass attached to the quarter panel, removing the quarter panel, performing a frame (or structure) pull if necessary, installing the new quarter panel, re-assembling parts onto the quarter panel such as side moldings, painting the door jam areas of the car, painting the damaged exterior of the car, including the newly installed quarter panel, and installing glass. Each of these tasks can require different human and physical resources than each other task. Moreover, any of the tasks, such as glass installation, may be performed by subcontractors.

Shops today lack systems for unbundling estimate tasks into discrete repair tasks such as those identified above. Shops today also lack systems for scheduling and tracking these repair tasks among the available resources of the shop, and systems for adding dependencies to repair tasks to ensure that repair tasks are performed in the proper sequence. If unbundling estimate tasks and scheduling is done at all it is done manually on an ad-hoc basis. For these reasons, repair tasks are frequently not performed in a timely way, are forgotten, or are performed out of sequence requiring costly reworking and delays. On average, for example, 15-18 days are required to perform 15 hours of work. Moreover, on-time delivery of repaired automobiles for the automobile repair industry and specifically the collision repair industry is approximately 37%.

To illustrate prevalent problems, consider the rear quarter panel replacement example described above. The dependencies among repair tasks require that some repair tasks are performed before others. Dependencies should be observed to ensure that the rear quarter panel glass is removed prior to the frame pull. However, if the repair tasks are performed out of sequence, the glass may be left in the car and is therefore vulnerable to breakage during the frame pull. As another example, replacement parts may be mistakenly installed after the painting step, thus requiring areas of an automobile to be repainted after installation of the parts. Each of these mistakes is common and results in delay and unrecoverable extra costs.

A significant additional problem with conventional repair shop operation centers around shops failing to provide services which maximize customer satisfaction. A significant cost of providing automobile insurance is the cost associated with losing insurance customers as a result of the customer's bad experience with the insurance claim process. Costs of re-acquiring lost customers and acquiring new customers are sufficiently high that insurance companies seek to minimize customer losses.

The insurance claim process begins with reporting an accident to an insurer or insurance agent and ends with the customer receiving either a repaired car or a check from the insurance company. Empirical data show that a customer's impression of the quality of her insurance company after completion of an automobile insurance claim is largely determined by the customer's experience with the repair shop that actually performs the repair. For this reason, a large part of an insurance company's image is almost completely out of the direct control of the insurance company. Demoralization of a customer can result in a customer not only canceling an automobile insurance policy with an insurer, but also other policies including homeowner insurance policies and life insurance policies.

To offset costs associated with losing and re-acquiring customers, insurance companies have instituted programs that attempt to force shops to comply with operating procedures that seek to increase customer satisfaction. These procedures may include calling the customer within, for example, 24 hours of receiving notice of an insurance claim, setting certain cycle time goals for repairing automobiles and requiring quality checks prior to and after delivery of the repaired automobile to the customer.

While these procedures help to ensure that automobile repair shops focus on customer service, there is no way for the insurance company to effectively monitor compliance. Inherent variability and unpredictability in operations make it difficult and costly to implement the compliance procedures. Moreover, the procedures may be difficult for shops to implement for numerous other reasons including: the need to add additional complicating steps, employee reluctance to change, training costs, monitoring costs and problems associated with organizing and using procedure documents from many different insurance companies.

Today, once an insurance claim is received at a repair shop, the scheduling of tasks such as contacting the customer to discuss the repair, scheduling delivery of the car, scheduling the estimate and individual repair tasks are done on an ad-hoc basis by estimators, administrative personnel or managers within the body shop. Scheduling is not done in an efficient manner to ensure that all resources at a shop are devoted to the most important and appropriate task at all times to ensure on-time delivery and compliance with required insurance company procedures. Therefore, shops today have chronically poor on-time delivery, long cycle times, don't contact customers in a timely way and don't diligently inform customers in advance of delays, all resulting in poor customer satisfaction. Moreover, there is not an efficient way to monitor the processing of insurance claims and to report on the progress of individual automobile repairs corresponding to the insurance claims or the aggregate performance of individual automobile repair shops. There is also no present way to efficiently monitor the very recent historical performance of individual shops or the current and future work load of an automobile shop. For this reason, today, insurance claims are routinely assigned to shops that have poor compliance with DRP procedures or to shops without sufficient capacity to complete repairs in a timely way.

For these reasons, there is a need for a new system for scheduling tasks within automobile repair shops. There is a further need for a network based platform to maintain a database, which is synchronized periodically with shop databases, which has up-to-date information on the present and future workload of individual shops and statistical information about the performance and degree of compliance with DRP procedures of individual shops. There is still a further need for the platform to facilitate insurance claim processing by facilitating assigning repairs to the best shop, facilitating the exchange of status and other information (including the claim itself, estimates and digital photographs) between the repair shop, insurance agents, rental car companies, the car owner and other interested parties. There is still a further need to streamline the process of scheduling and tracking automobile repairs to eliminate or reduce the number of redundant tracking systems used by insurance carriers, automobile repair shops and others and to reduce the number of redundant personnel performing quality control tasks such as final inspection of repairs. There is still a further need for a platform which provides reporting on the up to date automobile repair data and statistics to put this information to valuable economic uses.

### SUMMARY OF THE INVENTION

According to one embodiment of the invention, a method of coordinating automobile repairs includes maintaining in a first database statistics for automobile repairs. The statistics are automatically updated based on data from terminals at automobile repair shops, insurance carriers or their agents and/or other locations. In one embodiment, the statistics are shop specific and are updated based on repair data associated with individual automobile repair orders at each of many individual body shops. The method further includes receiving insurance claim data relating to the repair of an automobile and processing the statistics based on the insurance claim data to facilitate assigning an insurance claim associated with the insurance claim data to one of the plurality of body shops.

The assignment of the claim may be made by an insurance agent based on qualifying shops identified to the agent. Alternatively, the assignment may be made by a customer or automatically based on geographic information about the car owner and/or the accident, insurance company requirement data, the shop specific statistics and/or shop specific repair order data.

The shop specific data may include, for example, available capacity, customer satisfaction index (CSI), cycle time, customer call performance, on-time delivery, employee satisfaction, throughput, dead time, labor utilization, asset utilization and labor productivity. The CSI is based on feedback from customers who have had their automobiles repaired. The feedback from each customer is scored with higher scores being awarded for satisfied customers and lower scores for unsatisfied customers. The scores for customers of each automobile repair shop are aggregated and averaged to determine the CSI for each shop.

According to another embodiment of the invention, a platform for managing insurance claims includes an input/output unit, a memory, and a processor. The input/output unit communicates with insurance company computers and repair shop computers via a communications network. The memory stores program instructions and includes a database for storing shop specific statistics for a plurality of body shops. The shop specific statistics are automatically updated based on repair task data associated with individual automobile repair orders at each individual body shop. The processor executes the program instructions to: a) update the statistics in the database based on the repair task data received from shop computers, b) receive insurance claims from insurance company computers, each insurance claim including claim data relating to the repair of an automobile, and c) process the insurance claims.

According to another embodiment of the invention, a method maintains automobile repair data and automatically notifies interested parties of events. The method includes maintaining in a database statistics for specific body shops. The shop specific statistics are automatically updated based on events associated with individual automobile repair orders at each body shop. Notifications are generating automatically based on the statistics and are transmitted to interested parties. Additionally, reports may be generated to apply data from the database to many economically valuable uses.

The above described features and advantages of the invention will be more fully appreciated with reference to the detailed description and appended figures.

### BRIEF DESCRIPTION OF THE INVENTION

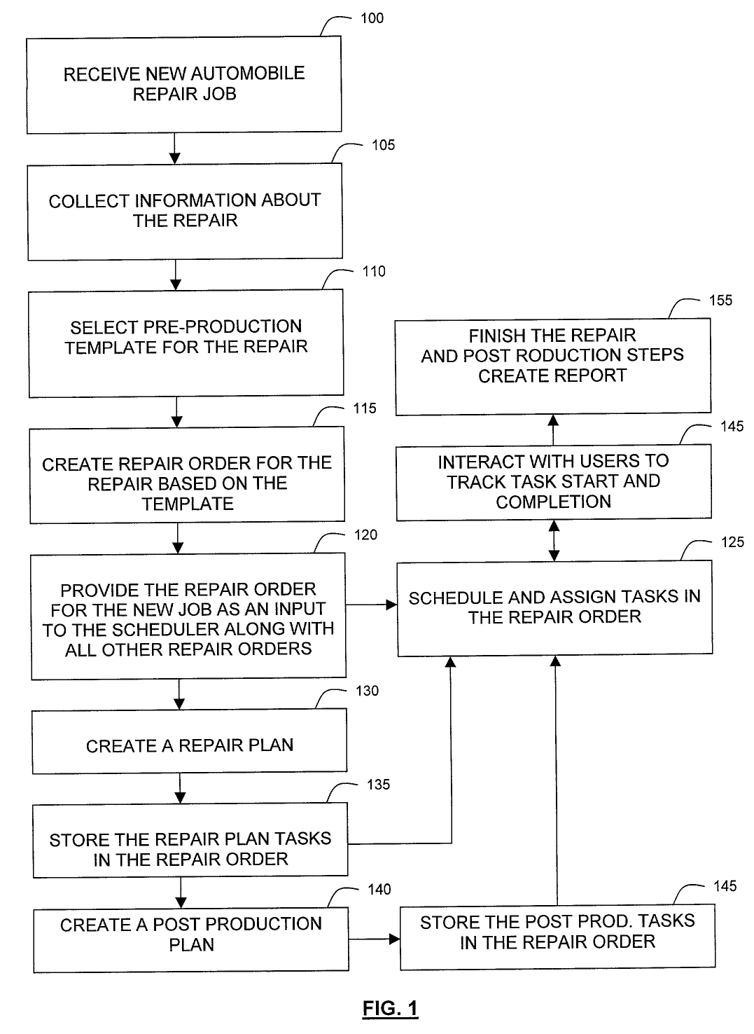

FIG. 1 depicts a method of processing an automobile repair order to identify and schedule repair tasks according to an embodiment of the present invention.

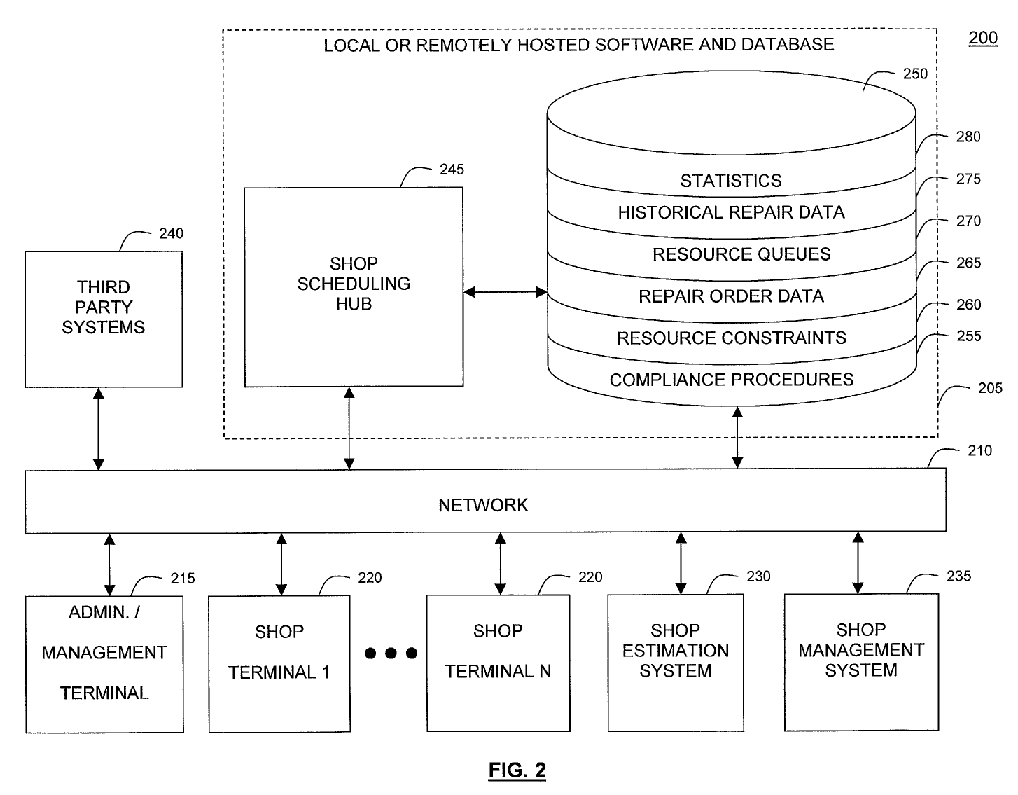

FIG. 2 depicts an arrangement of systems within or associated with a repair shop for scheduling repair orders according to an embodiment of the present invention.

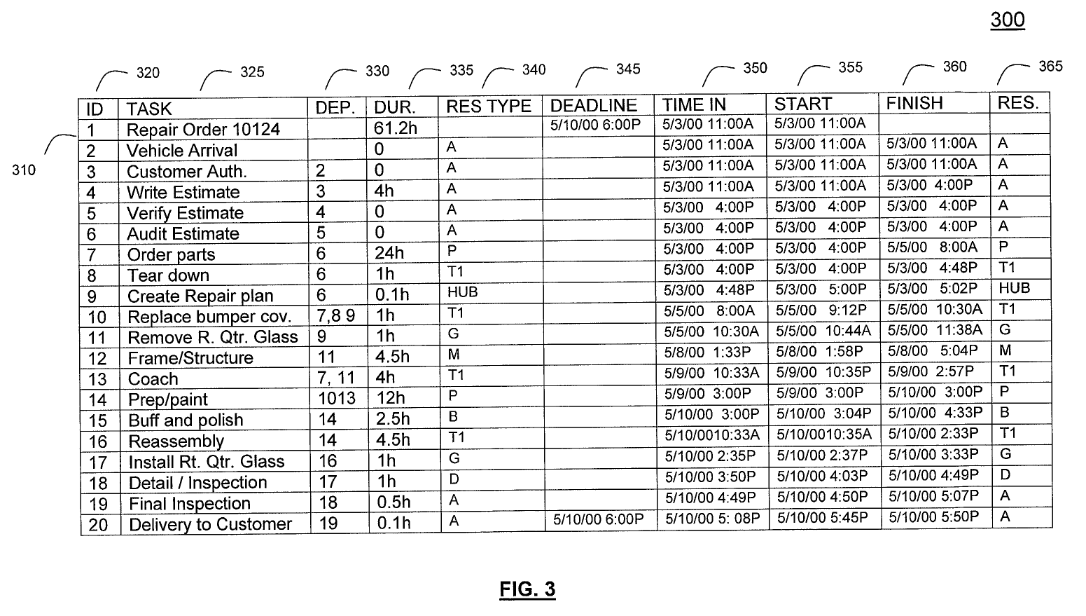

FIG. 3 depicts an illustrative repair order according to an embodiment of the present invention.

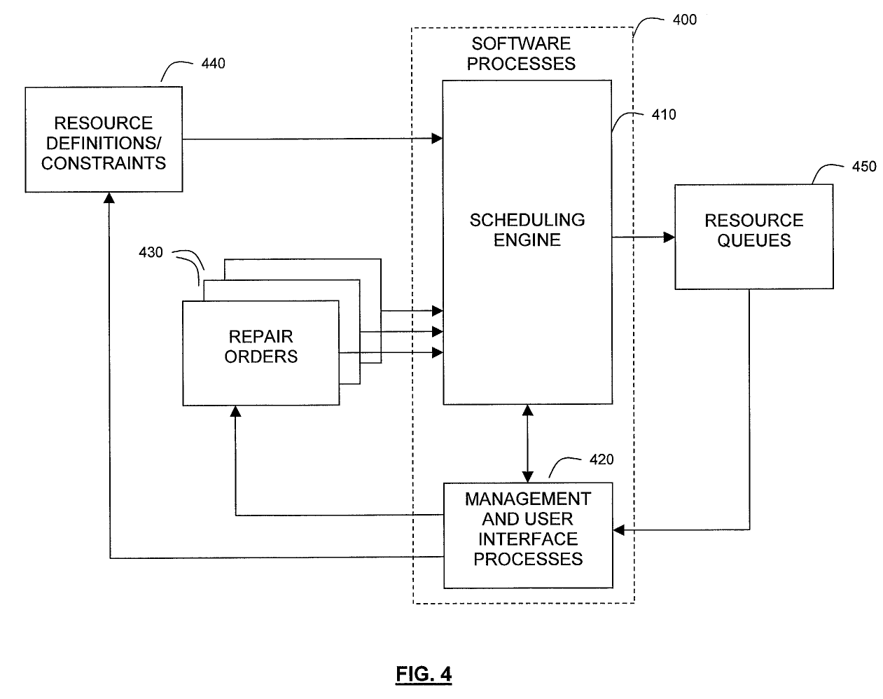

FIG. 4 depicts a functional block diagram of the scheduling according to and embodiment of the present invention.

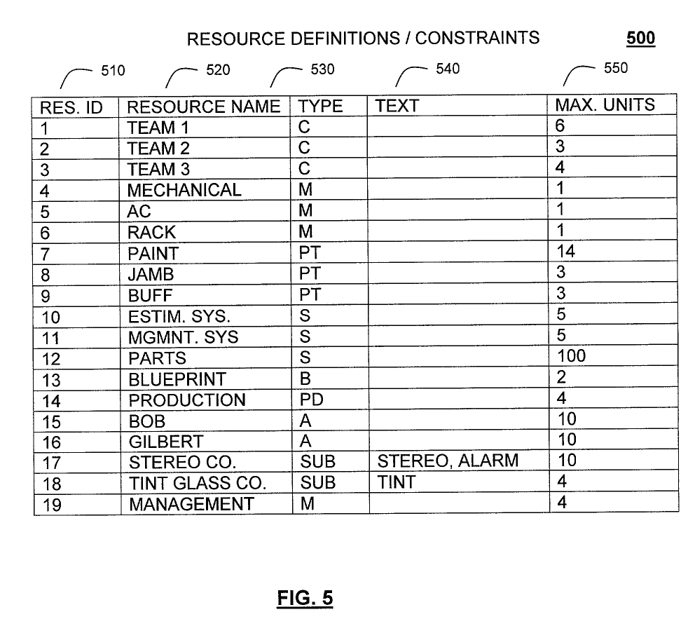

FIG. 5 depicts resource definitions and constraints according to an embodiment of the present invention.

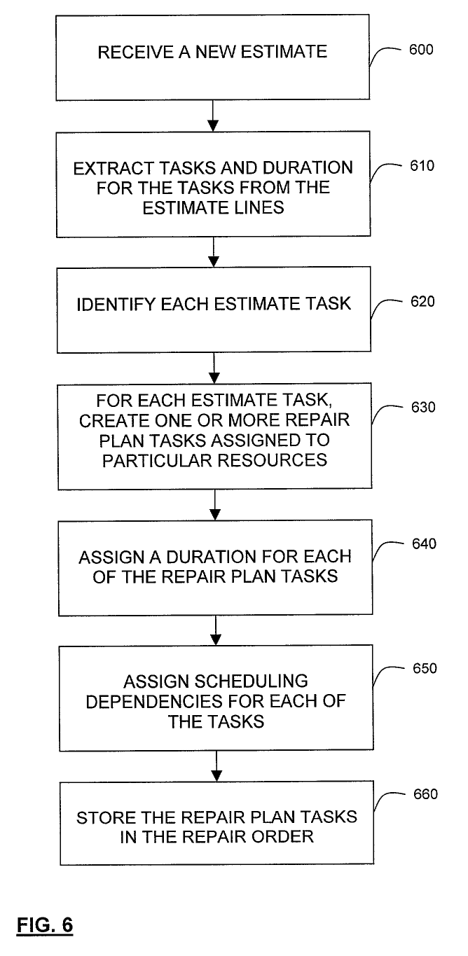

FIG. 6 depicts a method of creating a repair plan according to an embodiment of the present invention.

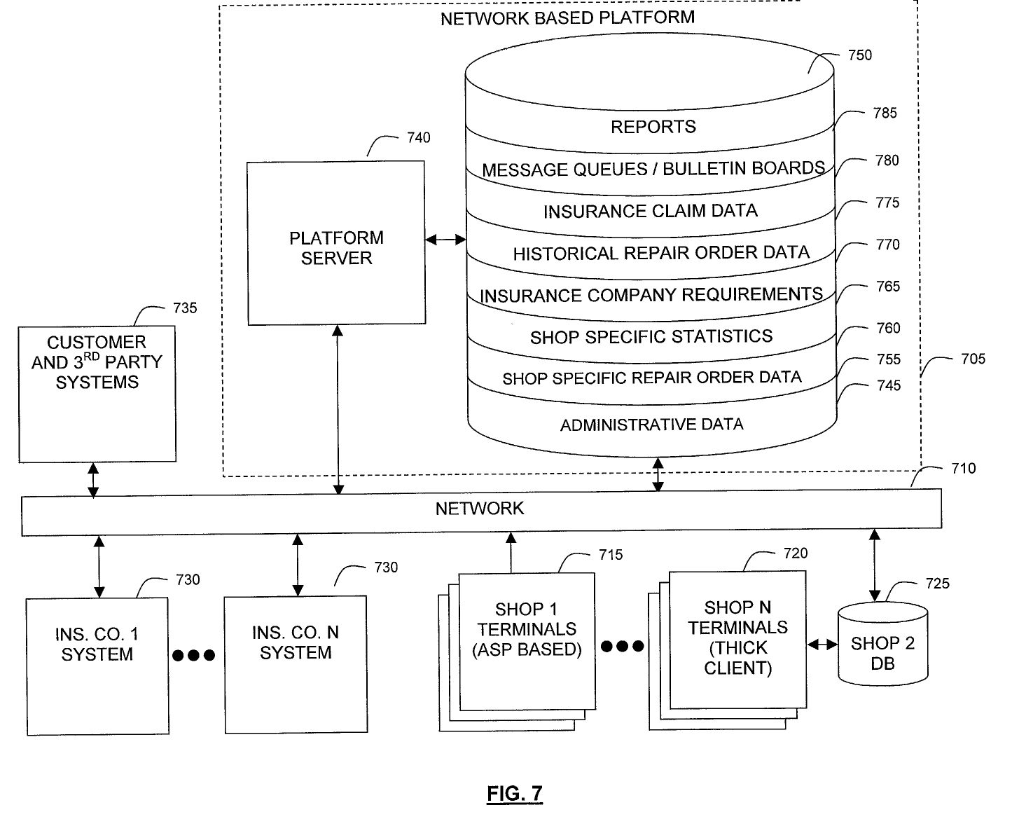

FIG. 7 depicts a functional block diagram of the network based platform according to an embodiment of the present invention.

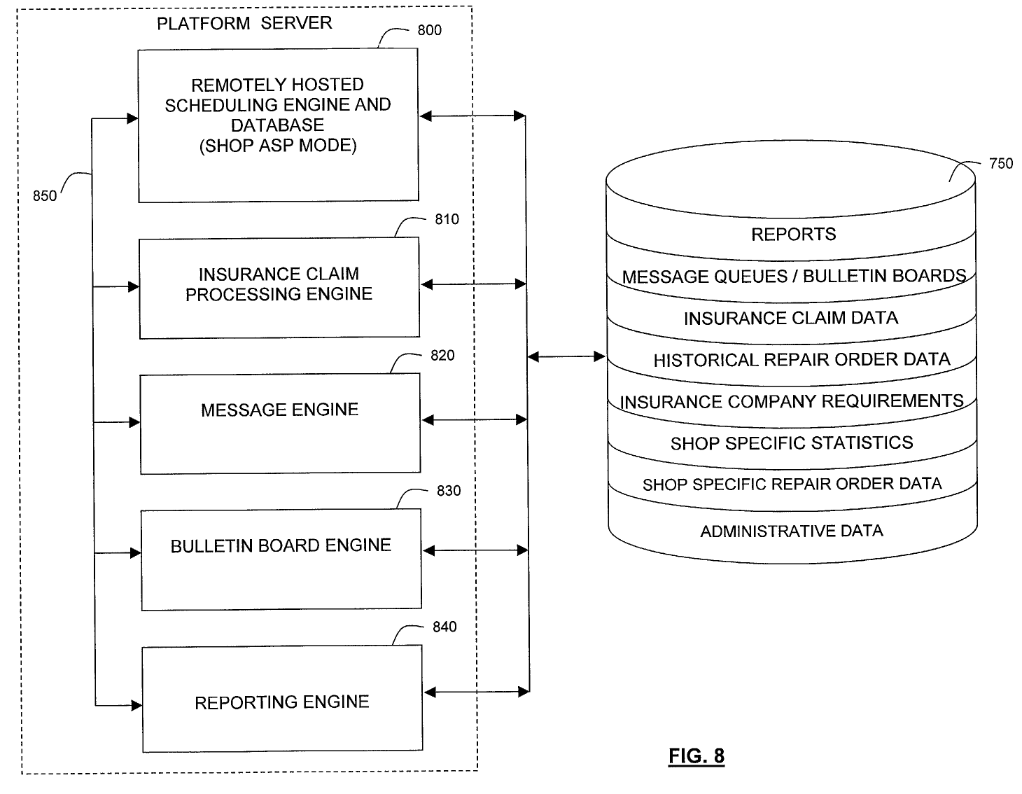

FIG. 8 depicts functional aspects of the platform server and their interaction with the database according to one embodiment of the present invention.

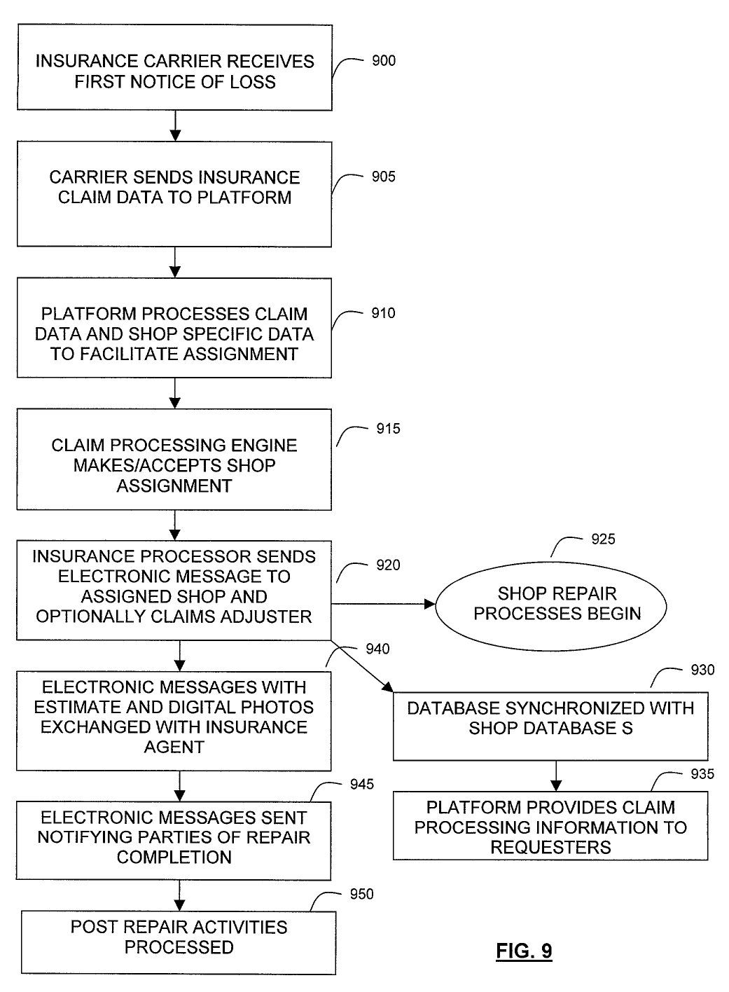

FIG. 9 depicts a method of processing an insurance claim according to one embodiment of the invention.

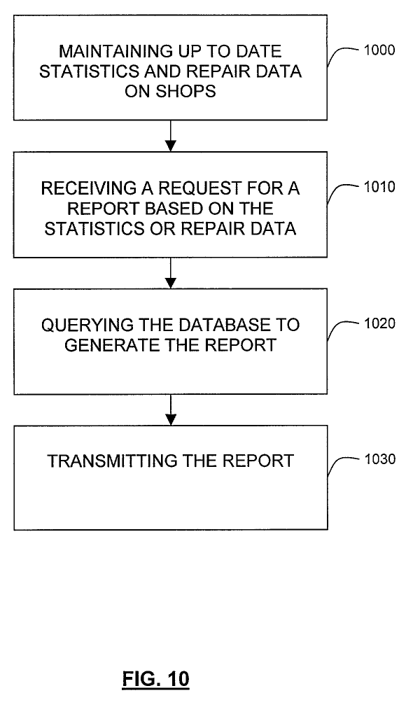

FIG. 10 depicts a method of providing collected repair order data to those to whom it has economic or other value according to one embodiment of the present invention.

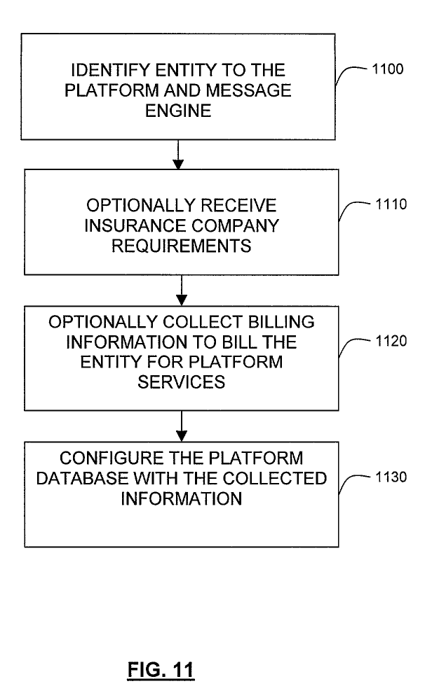

FIG. 11 depicts a method of configuring the platform according to embodiments of the present invention.

### DETAILED DESCRIPTION

### Scheduling Repair Tasks Within A Shop

FIG. 1 depicts a method of creating and processing an automobile repair order to schedule repair tasks according to an embodiment of the present invention. The term “repair order” is frequently used in the automobile repair industry to refer to a general statement of work which is to be performed to repair a particular automobile, which may be signed by the customer in advance to authorize work to proceed. As used herein, the term repair order is meant to convey any information, document or data, including a statement of work signed by the customer, an estimate, or a detailed, itemized list of tasks that are to be performed by particular resources of a shop, that identifies any work to be done in any level of generality and at any stage for a particular automobile. The repair order may be initially created, for example, with information merely identifying a customer, an automobile or an insurance claim. Subsequently, tasks may be added to the repair order, or inferred/deduced from information in the repair order or other source of information, and scheduled according to embodiments of the invention. Tasks may include pre-production tasks, such as contacting the customer to discuss a repair and arranging delivery of the automobile, estimate tasks, each of which may require one or more shop resources and repair tasks, repair tasks and post production tasks, such as final inspection and delivering the car to the customer.

The method of FIG. 1 includes a step of scheduling all tasks associated with a new automobile repair order along with tasks associated with all other automobile repair orders in the shop. A scheduling engine schedules each task among the available resources of the shop in order to, for example, optimize the chances for on-time delivery of each automobile repair tasks being handled by a shop. Scheduling may be performed based on repair order deadlines, task deadlines and/or statistical information describing the shop. The statistical information may include any convenient information that a shop may seek to maximize or use as a constraint in scheduling repairs, such as: cycle time, on-time delivery, labor productivity, dead time and return on assets. In addition, scheduling may be performed based on a characterization of the severity of a repair order. In so doing, a place-holder may be defined for future allocations of resources based on the characterization of severity and the scheduling may be performed based on the placeholder.

In order to more fully appreciate the method of FIG. 1, an overview of an embodiment of hardware and software within or associated with an automobile repair shop 200 is presented in FIG. 2. Referring to FIG. 2, the automobile repair shop 200 includes a local or remote shop server 205 coupled over a network 210 to an administrative or management terminal 215, a plurality of shop terminals 220, at least one shop estimation system 230, a shop management system 235 and a third party system 240.

The shop server 205 includes a shop scheduling hub 245 and a database 250. The shop scheduling hub may include a scheduling engine and other software for implementing the processes of creating repair orders and repair plans within repair orders, scheduling tasks within repair orders among the available resources of the shop, tracking repair orders and creating customized reports based on data collected.

The database 250 is disposed in communication with the shop scheduling hub 245 either directly or through the network 210. The database includes records relating to the business of the automobile repair shop that may be made available to all systems coupled to the network. The database is particularly useful for interacting with a scheduling engine within the shop hub and the terminals to store and provide data created or used during the scheduling process and the actual performance of the scheduled repair tasks.

The database may include compliance procedures 255, resource constraints 260, repair order data 265, resource queues 270, historical repair data 275 and statistics 280. The compliance procedures 255 may be used to store templates of tasks that third parties, such as insurance companies, primary contractors or customers, require the shop to perform in connection with an automobile repair. The compliance procedures may include direct repair procedures (DRPs). The resource constraints records 260 store a characterization of a shops resources, which may include human resources, equipment, space, materials or any other constraint affecting the ability of a shop to perform on a scheduled task. An embodiment of a constraint record for a shop is shown in FIG. 5.

The repair order data record 265 may include data on all repair orders which have tasks that are actively being performed. The resource queues 270 store tasks for each resource that have been assigned to that resource and are either awaiting or amid execution. The historical repair data record 275 includes data on past automobile repairs handled by the shop 200. This data may be used in conjunction with data about the location and severity of damage to an automobile to determine a subset of parts and tasks required for a repair prior to performing an estimate. This data may be used to create tasks such as parts ordering which may begin even before the automobile arrives at the shop to be repaired.

The statistics record 280 may include data that is derived from any of the data in the database and stored as a statistic. For example, detailed reporting based on the historical repair data records 275 and the repair order data 265 may be performed to mine data relevant to the shop's business. Such data may include cycle time, dead time, work on hand, available capacity, resource utilization, compliance figures associated with individual compliance procedures, root cause of delay, performance of resources or any other useful statistic.

The server 205 may be physically located within the shop 200. Alternatively, the server 205 may be located anywhere and connected over the network 210 to the systems 215-240. In one embodiment of the invention, the server 205 is operated by an application service provider (ASP) who remotely hosts scheduling applications and data storage according to the present invention. In an alternate embodiment of the invention, the server 205 is physically located within the shop. It will be understood that according to the present invention, any convenient server configuration may be implemented. It will be further understood that while only one server with one database is depicted, multiple servers in different locations may be implemented and multiple databases may be implemented. When multiple databases are implemented, for instance local and remote databases, the databases may be synchronized at periodic intervals, in response to the occurrence of predetermined events or to the completion of tasks, the expiration of a deadline or at any other time.

The network 210 may be a local area network, a wide area network, the public switched telephone network, the interconnected backbones, routers, bridges, switches and servers known as the Internet, other communications links and combinations thereof. The network may include direct electrical connections, wireless, optical or any other communications links, including analog, digital, circuit switched and packet switched, for transmitting information.

The administrative/management terminal 215 may be used, for example, to interact with the server 205 and other systems to authorize new repair orders, receive alerts when a particular repair order falls behind schedule, monitor and create reports, adjust resource deployment, create or alter repair orders.

The shop terminals 220 may interact with the server 205 and other systems to present screens to human resources within the shop 200. The terminals may, for example, present a login screen. Repair technicians or other personnel within the shop may log in through the login screen and then view or interact with various screens that may be useful. For example, repair technicians may be presented upon logging in with the tasks that are in their queue and waiting to be started or finished. The repair technicians may interact with the screens to provide data back to the server 205 for use in scheduling processes. For example, start and finish times may be entered.

The shop estimation system 230 may be used to create or update estimates, store and transmit digital images of damaged automobiles. The shop management system 235 may be used to import estimates, alter estimates in accordance with insurance company constraints, place parts orders via the network 210 to third party systems 240, billing and other administrative purposes.

The third party systems 240 may be computer systems of any entity with which the shop interacts electronically. For example, the third party systems 240 may include an insurance company or agent computer system from which insurance assignments are received and with which information on claims processing and repair progress is exchanged, rental car companies, parts manufacturers or other suppliers, other subcontractors, other primary contractors for which the shop acts as a subcontractor or any other entity relative to which the shop 200 sends and/or receives information.

The method of FIG. 1 will now be described. Referring to FIG. 1, in step 100, the automobile repair shop 200 receives a new automobile repair job in its queue. Notice of the job may be received electronically from an insurance company computer in the form of an assignment. The data file may include information identifying the name, phone number(s) and address of the owner of the damaged vehicle, the insurance company name, insurance claim number, and insurance policy number of the car owner. The information may further include information about the damaged automobile, including the make, model, year, color and license plate number of the car, the severity of the damage and other information about the damage including location of impact and the severity of the impact at each location. A data file may also be received from third party systems 240, such as other automobile repair shops or other entities, including customers, requesting that work be performed by the body shop 200. As an alternative to a data file, the new automobile repair job may be described to the automobile repair shop through oral, written, fax, email or any other communication. Shop personnel may interact with any of the terminals 215-220 or systems 230-235 to take information regarding a new repair job and enter it into a repair order recognized by the shop scheduling hub.

In step 105, the shop hub collects information about the repair. The information may be taken directly from the data file. Alternatively, the information may be manually entered by shop personnel or another party based on the information received orally, in writing, by fax or email in step 100. In still another embodiment, a user of a terminal 220 or 225, system 230 or 235, or third party system 240 may interact with a menuing system to facilitate entering information about the repair into the shop hub. The menuing system may include, for example, screens that are displayed to users to facilitate interaction, voice menus which prompt users to enter or speak information or any other convenient menuing techniques. The techniques for inputting information described above are illustrative of the numerous possibilities and any type of data entry or information gathering technique is contemplated here, including voice recognition, text recognition, and data processing generally.

The information collected may include any or all of the information described above relative to step 100. The information may further include whether the car is capable of being driven, whether a tow truck is required, whether an estimate has been written or needs to be written, whether the damaged automobile has been delivered to the shop or not and any other information desired for pre-production processing.

In step 110, the shop hub selects a pre-production template for the repair job based on the information entered in step 105 and the compliance procedures 255. The pre-production template includes specific pre-production tasks that must be scheduled and performed by resources within the shop pursuant to an insurance company's (or other entity's) procedures. Pre-production tasks include calling the customer to schedule delivery of the car, writing and verifying an estimate, contacting the customer to obtain customer approval for the repairs, contacting the insurance company to receive insurance company approval, ordering parts, scheduling a rental car, scheduling a tow truck, and creating a repair plan. Any tasks requiring communication with another entity outside of the shop may be performed by exchanging electronic messages over the network with the entity.

In step 115, the a repair order is created for the new repair job based on the pre-production template. The repair order may be created automatically by the shop hub. Alternatively, the repair order may be created manually through interaction between personnel and any of the terminals or systems 215-245 or a combination of manual interaction and automatic creation. In still another embodiment, the repair order may be created by a third party system 240 or other entity and received by the shop hub via the network 210 for processing.

The repair order includes a list of tasks associated with preproduction that need to be scheduled and assigned to resources within the shop. For each task, dependencies identifying which other tasks must be completed first are identified either through position within the task list or by explicitly identifying the other tasks which must be first performed. A projected duration for each task is also included. During subsequent scheduling of the tasks, other information may be added to the repair order including the assigned resource, the time that the task was given to the assigned resource, the time that the assigned resource started the task, and the time the resource finished the task. An illustrative repair order (without customer and insurance data) is presented in FIG. 3. The repair order may include a deadline for overall completion as well as a deadline for the completion of individual tasks. The deadline for completion of individual tasks may be determined based on compliance procedures. For example, in the case of a 24 hour customer contact procedure, the deadline for contacting the customer is 24 hours. This deadline is associated as data with the task of contacting the customer.

In step 120, the repair order for the new job is stored in the repair order data record 265 to be included as an input to the scheduling engine within the shop hub along with all other repair orders being processed by the shop 200. At this stage, the car that is to be repaired may or may not have been delivered to the shop for the repair. The scheduling of tasks such as contacting the customer, and arranging for delivery and scheduling shop resources for repairs may begin prior to receiving the damaged automobile. Moreover, based on resource availability and optionally a characterization based on severity, the scheduler may schedule a delivery time for the car to ensure that the car does not arrive until the shop is ready to begin work. This is particularly advantageous for the customer when the damaged automobile is capable of being driven. In addition, a shop may determine a placeholder for shop resources based on the characterization of severity and perform scheduling based on the place holder.

In step 125, the shop hub accesses the repair order data 265, retrieves the new repair order, and schedules the pre-production tasks, along with all other tasks in the shop, among the available resources of the shop 200. The scheduling engine includes an algorithm for scheduling tasks within the shop to select which tasks should be performed next in order to maximize the likelihood of completing all or most repair orders, and all tasks which have associated deadlines, on time. The algorithm may also be adjusted to realize or emphasize other scheduling goals. For example, the scheduling may be performed based on repair order deadlines, task deadlines, statistical information describing the shop or combinations thereof. The statistical information may include, for example, any convenient information that a shop may seek to maximize or use as a constraint in scheduling repairs, such as: return on assets, labor productivity, cycle time, dead time and on-time delivery. The statistical information may be applied as a weighting factor to the scheduling algorithm to, for example, increase the priority of smaller repair jobs if smaller repair jobs are more profitable or use assets more efficiently. The statistical information may optionally include, for example, acceptable program compliance deviation information which would permit a shop to allow a certain percentage of program compliance deviations when necessary to achieve other scheduling goals. In addition, the method may include characterizing the repair order based on severity and scheduling based on the characterization.

In the case of the pre-production tasks, and the tasks generally, the shop hub may apply data from constraint procedures, such as DRP procedures, to associate deadlines with particular tasks as identified above. These deadlines are used during the scheduling process, along with a projected duration for each task in the repair order, to determine the optimum resource allocations and which tasks have the highest priority and should therefore be assigned to human and other resources.

In step 130, the shop hub creates or receives a repair plan for the repair order. The repair plan may be entered through a terminal 215, received over the network 210 from a data source or may be created automatically from an estimate. The repair plan includes repair tasks that must be performed by resources within the shop to complete the repair. The repair plan includes dependencies among the tasks, a duration for each task and a resource type that is required for the task. In step 135, the repair plan is stored as part of the repair order for a repair job. An illustrative repair order including a repair plan is shown in FIG. 3.

In step 135, the repair plan is stored with the repair order in the database 250. Once the repair plan is stored as part of the repair order, the tasks associated with the repair plan of the repair order may be picked up by the scheduling step 125 and scheduled, along with all other tasks, among the available resources.

In step 140, a post-production plan is created having specific post-production tasks. These may include detailing the automobile, final inspection and scheduling a customer satisfaction appointment with an independent CSI agency. FIG. 3 illustrates a repair order and post-production tasks associated with the repair order.

In step 150, assigned tasks and associated start and completion times are displayed to shop personnel. In this regard, the terminals 215 or 220 may display to shop personnel the tasks that are assigned to each person (or group of people) as specified in the resource queues 270. The terminals 215 may each run a software application which reads and/or writes the resource queue of the database. The application may also display for each person in the shop the list of tasks in their queue and may allow each person to update start and completion times for their tasks. These entries update the repair orders in the database and allow the scheduling step to schedule and assign new tasks when previously assigned tasks are completed. In addition, employees may be permitted to, for example: provide attendance data for updating the resource constraints through the terminals (or other equipment, such as badge readers) in the shop; provide data for updating the resource constraints regarding availability of themselves or others for particular types of tasks; and provide any other data that may be useful for scheduling tasks.

In step 155, the shop personnel (or subcontractors) finish the pre-production, repair and post-production tasks, the repair order is finalized and the automobile is returned to the appropriate entity. All of the data from the repair order, including task descriptions, start and stop times collected during the scheduling process and parts ordering data (including any associated delays), may be stored as historical repair data in the database 250. This data is then mineable to generate statistics, to search for root causes of delay in order to change or redeploy shop or third party resources relied upon, to generate reports, documentation or for any other reason.

FIG. 3, which was referenced above in the description of the method of FIG. 1, depicts an illustrative repair order 300. The repair order includes a plurality of tasks 310. Each task may have a task ID 320, a task description 325, dependencies 330, a duration 335, a resource type 340 which defines the resources that are required to perform the task, an optional deadline 345 for the task, an assigned resource 365, a time in 350 indicating the time at which the task is placed in the queue of the assigned resource 350, a start time 355 for the assigned task and a finish time 360 for the assigned task. Any and all of the information depicted in FIG. 3 may be displayed in screens, in whole or in part, to shop personnel via the terminals 215 or 220. The fields 350-365 may be filled in by the scheduling engine as tasks are assigned to resources within the shop or by shop personnel through the terminals 215 or 220.

FIG. 4 depicts a functional block diagram of the scheduling features of an embodiment of the present invention. Referring to FIG. 4, a scheduling engine 410 and a management and user interface processes block 420 may be implemented as software processes. Either or both of the software processes may run on the shop hub 245. The management and user interface processes 420 may run on the terminals 215 and 220. Moreover, the scheduling engine 410 and the management and user interface processes 420 may be part of the same software application or may be different software applications. One or both of the software processes 400 may be installed on a single server 205 and served to shop personnel in an application service provider or other software hosting mode. Alternatively, one or both of the software processes 400 may installed at the shop scheduling hub 245 and at each of the terminals 215 and 220. The scheduling engine (and management and user interface processes) may be implemented using virtually any project management software, including Project available from Microsoft Corp., Team Center available from Inobie Software, Inc., Team Play available from Primavera Software, and Web Project available form Web Project, Inc. A scheduling engine may also be created using any suitable programming language such as C, C++, Java or any other programming language in a well known manner. The management and user interface processes may be implemented using a browser, an editor, spreadsheet software, project management software or any other software for facilitating the display and capture of data.

During operation of the software processes 400, the scheduling engine 410 interacts with the database 250 to retrieve and schedule tasks among available resources. For example, the scheduling engine 410 receives inputs from the resources definitions and constraints data 440 and the repair order portions of the database 205 for the shop 200.

For each task in each of the repair orders, the scheduling engine assesses its priority based on the deadline each repair order, the duration required for completion of each remaining task in the repair order, dependencies among tasks, any deadlines for individual tasks and resource constraints. The scheduling engine 410 interacts with the database 205 automatically, to repeatedly perform the scheduling at periodic intervals, or to perform the scheduling in response to events such as completion of a predetermined number of tasks, receiving a new repair order or any other convenient trigger point. After scheduling, the tasks are scheduled and assigned among the available resources of the shop. Assigned tasks are written to the resource queues 450 stored in the database 205 for each resource receiving a task assignment.

The management and user interface processes 420 may interact with the resource definitions/constraints data 440, the repair orders 430, the scheduling engine 410 and the resource queues 450. For example, the management and user interface processes tool may be used to update the resource definitions/constraints data 440 based on actual employee attendance at the shop in real time, to add new resources, redeploy a resource by changing its type, add additional units of a resource based on efficiency gains or purchasing additional equipment, to enter or change hours of operation of the shop or any other information affecting the ability of the shop to perform tasks. Data reflecting actual employee attendance may be generated and tracked in any well known manner including assigning employees badges, installing badge readers in the shop and requiring employees to badge in and out.

The management and user interface processes 420 may also create or display screens on the terminals 215 or 220, which may be interactive. These screens, such as active server pages, permit personnel to see their queue of tasks and update their queue of tasks based on actually starting tasks and completing tasks. The information received at from personnel may then be stored in the database as updated repair orders or other information. The scheduler automatically picks up the updated repair orders and performs repeated scheduling resulting in new task assignments after old task assignments are completed. The management and user interface processes may also include generating reports based on any of the data in the database 205. In addition, the management and user interface processes 420 may be used to generate alerts in the form of electronic messages via the terminals 215 or 220 to managers or other personnel within the shop, or to third parties at third part systems 240, when a future deadline may be missed. The management and user interface processes 420 may also be used to generate reports on the status of individual repair orders based on time associated with tasks completed as a ratio to time remaining to completion based on the sum of the duration of the tasks which remain to be completed. Status may be determined and reported based on other or additional criteria including available resources and projected completion dates and times.

An example of a resource definition and constraints data is illustrated in FIG. 5. Referring to FIG. 5, the resource data 500 may include a resource ID 510 for each resource, a resource name 520, a resource type 530, a resource description 540 and an indication of the number of units 550 associated with the resource. The resources themselves may be people, space, equipment, software tools, subcontractors or other third parties or any other resources or entities that a shop may rely on in processing an automobile repair. Human resources may be characterized in many different ways. Each person may be considered a single resource of one unit for performing a certain type of task. Alternatively groups of people may be considered to be a single resource having multiple units for performing one or multiple different types of tasks. In still another variation, individual people may be considered to have multiple units for certain types of tasks. For example, administrative personnel who are responsible for ordering parts, calling customers to arrange for delivery or pickup of automobiles may be considered to have many units. This permits the scheduling engine to assign multiple simple tasks to the same person, such as calling the customer, and as such allows the person to have a reasonably full queue in case the person cannot perform some of the tasks because, for example, the customer is not available by phone.

The resource type 530 may be applied to human resources and all other resources. The resource type 530 is in conjunction with the resource type designation 340 found in the repair order. These fields are used to ensure that the scheduling engine 410 performs its scheduling analysis relative to the appropriate resources for each task and subsequently assigns tasks to the appropriate resources. In an automobile repair shop generally and a collision repair shop specifically, the resource types include coach (or body), mechanical work, painting work, systems work, estimating, blueprinting, production, administrative functions, management functions and subcontractor functions.

FIG. 6 depicts a method of creating repair plans for repair orders based on data in estimates. Referring to FIG. 6, in step 600, a new estimate is received. Then in step 610, tasks are extracted from the lines of the estimate. The tasks may include ordering specific parts and performing specific tasks for specific periods of time. The specific tasks may include removing and replacing damaged parts with new parts, repairing damaged parts, frame work, mechanical work, removing and replacing glass, painting interior areas of the automobile, such as inside the trunk, and the exterior of the car, buffing the car and detailing the car as well as other tasks. As used herein the term “frame” is intended to encompass uni-body structures and other structures which provide the main support for an automobile.

For each extracted estimate task, the estimate task is identified and unbundled into one or more repair tasks. There may be more than one repair task for each estimate task and the repair tasks for estimate task may span more than one resource. In step 630, for each estimate task one or more repair tasks are assigned. The assignment is made based on repair plan data that may be maintained in the database 205 as resource constraint records. The repair plan data is a table of estimate tasks which specifies, for each estimate task, the type of resources that are required for the corresponding repair tasks. Also for each estimate task, the table specifies the percentage of the time specified in the estimate that should be allocated to each of the different repair tasks. The time allocation may be determined and inserted into the repair plan data based on the efficiency of the resources in the shop for performing the particular type of task, empirical data derived from the historical repair data or assumptions.

In step 640, a duration is assigned for each repair task for each resource based on the time allocated in the table. In step 650, scheduling dependencies are assigned for each repair task. These may be assigned through a user's interaction with a terminal 215 or 220 or the administrative/management terminal 215. Alternatively, the dependencies may be assigned based on a dependency table maintained in the resource constraints 260 portion of the database 250. The dependencies may illustratively include, for example: that a repair cannot proceed until customer approval has been received; that a part cannot be ordered until a decision has been made to replace rather than repair a part; that replacement part installation cannot be scheduled to occur before the ordered part has been received; that alignment of steering cannot be performed until the frame (or structure) has been straightened; or that painting of the exterior cannot occur until the last replacement part with an exterior painted surface is installed on the automobile as well as other conditions that may be identified in the dependency table on a task by task basis. In step 660, the repair tasks are stored in the repair order for the automobile. Scheduling of the repair plan tasks may occur.

### A Network Based Platform For Collecting and Leveraging Shop Scheduling Information

Shops which implement scheduling according to the present invention produce repair order data which may be regularly collected within a database associated with a network based platform. The repair data includes task data and other information about repairs presently being handled or scheduled to be handled in the future. By so doing, the network based platform maintains up to date and accurate information on the operation of many repair shops within various geographic areas. This platform may then be used by insurance companies to assign new repair jobs to automobile repair shops that are substantially compliant with their DRP procedures, that have available capacity presently or in the near future, or based on any other convenient criteria. The platform may also be used to facilitate the exchange of data between insurance companies and agents, repair shops, rental car companies, parts suppliers, subcontractors and, in general, any party with a need for automobile repair information. The exchanged data may include insurance claim data, estimate data, supplemental estimate data, digital photographs of damage and/or repairs and other information. The platform may also be used to provide status information to those who access the platform on the progress of individual automobile repairs as well as on the aggregate performance of shops.

FIG. 7 depicts a functional block diagram of the network based platform 705 according to an embodiment of the present invention. Referring to FIG. 7, the platform 705 includes a platform server 740 and a database 750. The platform server 740 interacts with the database 750 and with other computer systems over the network 710 to process automobile repair data according to the present invention. The other computer systems, which are also coupled to the network 710, may include insurance company systems 730, repair shop terminals 715 and 720, repair shop databases 725, customer (car owner) and other third party systems including, for example, those used by rental car companies, parts suppliers and subcontractors 735. The network 710 may be the same as the network 210 and the computer systems 715-740 may be the same as shown and described with respect to the computer systems 215-245 in FIG. 2.

The shop terminals 715 and 720 may be either thick or thin as shown in FIG. 7 and there may be more than one terminal per shop. When the terminals are thick, there may be scheduling software or tracking software that is stored on and run locally on the thick client. The scheduling or tracking software creates repair data and statistics about individual automobile repairs as well as the repairs being performed in aggregate in the shop. The repair data and statistics for a thick client may be stored in a shop database 725 as shown in FIG. 7. The shop database 725 may include the data shown and described relative to the database 250 in FIG. 2.

The database 750 of the platform 705 includes administration data 745, shop specific repair data 755, shop specific statistics 760, insurance company requirements 765, historical repair data 770, insurance claim data 775, message queues/bulletin boards 780 and reports 785. The administration data includes data such as: the userid and password of shop personnel, insurance company personnel, customers (damaged car owners) and other parties who use the platform 705; the name of the insurance company, shop or customer; billing information for the insurance company, shop or customer; the location or locations of the insurance company, shop or customer; account information for the insurance company or customer; access privileges and any other information that is useful for providing access to the platform and billing for services. It will be understood that each of the above examples applies to any entity or user with access privileges, regardless of what business the entity is in.

The shop specific repair order data 755 includes data on repair orders presently being handled or scheduled to be handled by each shop associated with the platform. The shop specific historical repair data 770 includes repair order data for automobile repairs handled in the past by each shop. The shop specific statistics 760 may be derived in an on-going fashion from the shop specific repair order data and the shop specific historical data. It may be useful for deriving statistics about the shop including cycle time, dead time, work on hand, available capacity, resource utilization, compliance figures associated with individual compliance procedures, root cause of delay, performance of resources or any other useful statistic. Each of the fields 755, 760 and 770 may be the same as the fields 265, 280 and 275, respectively.

The insurance company requirements 765 may include, for each insurance company: a list of DRP procedures which shops must follow, a tolerable percentage of compliance with each procedure and/or with the procedures in aggregate, a list of shops approved for use in connection with DRP repairs, additional procedures which affect the operation of the platform including rules or procedures governing the assignment of insurance claims, the transmission of estimates and the granting of approval to begin work on an estimate.

The insurance claim data 775 may include insurance claim data files for each insurance claim processed through the platform 705. The insurance claim data file may include the insurance company's name, the policy holder's name and contact information, a description of the insured property and a description of the damage. The insurance claim data may be updated over time with data from the estimate, and digital photographs if available, the name of the shop to which the claim is assigned, the date work started, the date work was completed, the date certain compliance procedures were met and any other convenient information.

The message queues/bulletin boards 780 are used to store information that is destined for a mailbox of a user recognized by the platform. For example, there may be mailboxes provided on the platform or off platform e-mail addresses for customers, shop personnel, insurance agents, subcontractors and other parties. The reports field 785 is used to store reports that are generated based on the data maintained in the database 750.

The operation of the platform 705 is described in more detail in FIG. 8. Referring to FIG. 8, the platform server 740 includes software components 800-850 which are executed in order to provide the functionality of the platform. The platform server 740 may include: a remotely hosted scheduling engine and database 800, an insurance claim processing engine 810, a message engine 820, a bulletin board engine 830, a reporting engine 840 and a user administration engine 850. Each of the components 800-850 may exchange data or other signals with each other component as illustrated functionally with line 860. The components are also coupled to the database 750. The components may also be configured as part of a single software package.

The remotely hosted scheduling engine and database 800 is used to provide scheduling of repair orders for shops in an application service provider (ASP) mode. The scheduling engine and database 800 may be the remotely hosted software and database 205 shown and described with respect to FIGS. 1-6. The database 250 shown in FIG. 2 as associated with the remotely hosted software and database 205 may be part of the platform database 750 or may be a separate database, with relevant portions being regularly synchronized with the database 750. In particular, the shop specific statistics, the shop specific repair order data and the historical repair data fields of the database 750 are either shared with the database 250 or synchronized with the corresponding fields within the database 250 for each shop.

The insurance claim processing engine 810 receives and processes insurance claims as shown in FIG. 9. In particular, the insurance claim processing engine 810 receives insurance claim data from an insurance agent after an insured makes a claim under an insurance policy. The insurance claim processing engine 810 then processes the insurance claim data to facilitate assigning and tracking the claim. The assigning of the claim may be performed based on the location of the customer or the damaged vehicle and insurance company requirement data in the database 750, the shop specific statistics and/or shop repair order data for nearby shops. The insurance claim engine may interact with the scheduling engine 800, the message engine 820, the bulletin board engine, the reporting engine, the administration engine or any of the other components of the platform server to initiate processes such as scheduling tasks, reporting status and transferring claim data or other data.

The message engine 820 interacts with the message queues and user 780 administration data 745 in the database 750. It allows electronic messages to be sent from any user of the platform 705 to a mailbox or e-mail address of any other user of the platform. Such messages are stored in queues associated with the recipient. Electronic messages may also be generated automatically by, or in response to a user's interaction with, any of the components of the platform server and placed in a user's mailbox. Illustrative examples of electronic messages include insurance claim data which may be stored in an assigned shop's mailbox, estimate data which may be sent to an insurance agent's mailbox from a shop, status messages to particular users, reports and any other type of message.

The bulletin board engine may be used to post notices to users of the network based platform. For example, notices of claims may be posted by insurance companies or agents and shops may respond to the postings to be considered for selection. In addition, individuals who need automobile repairs may post their contact information and a description of their requirements or a digital image of damage on the bulletin board for shops associated with the platform to either bid for or indicate interest in. Responses to bulletin board notices may be made in the form of electronic messages sent to the entity receiving responses to the notice via the message engine 820.

The reporting engine 840 interacts with users of the platform 705 to extract meaningful information from the database 750. For example, the reporting engine 840 may be used to query the shop specific statistics and insurance company requirements to produce a report showing which shops are compliant with insurance company procedures and to what degree. Reports may also be tailored to determine the status of an individual automobile repair or insurance claim, to analyze the past, present or future workload of automobile repair shops in a given geographic region to predict demand for rental cars in a region based on past, present or future repair order data, to determine costs associated with the failure of certain automobile parts or any other useful information.

FIG. 9 depicts a method of processing an insurance claim according to one embodiment of the invention. Referring to FIG. 9, in step 900, an insurance carrier receives notice of a loss. Typically, the loss results from an automobile accident in which the insured's car is damaged. Any other insurable loss is contemplated, however, including vandalism and natural disasters. In step 900, the insurance company receives the name of the insured, the policy number of the insured and details about the damage In step 902, a computer sends insurance claim data to the platform. The insurance claim data may be sent automatically, at the behest of an insurance agent or any other entity. The insurance claim data typically includes the insurance company name, the policy number, the name and contact information for the insured, a description of the car and damage and any other useful information.

In step 910, the platform processes claim data and shop specific data to facilitate assignment of the claim. The processing may take many different forms, depending on the desired implementation for each insurance company and each claim. The following examples illustrate different implementations.

### Example 1—Insurance Agent or Customer Chooses the Shop

An insurance agent receives notice of a claim under an automobile insurance policy as a result of an automobile accident. The accident occurred in Santa Monica, Calif. The insurance agent logs onto the platform and interacts with the insurance engine to provide: the location of the damaged automobile or the car owner as and address in Santa Monica; the name or some other identification of the insurance company that issued the policy; and optionally, for example, a maximum 30 mile distance that a shop may be from the car owner or location of the damaged vehicle that is acceptable. In response, the insurance claim processing engine 810 queries the database 750. Based on the insurance company requirements and shop specific statistics, the database returns a list of shops within 30 miles of the address in Santa Monica that also meet the compliance levels specified for the insurance company in the insurance company requirements record 765. The insurance agent may then select one of the shops for the repair and transmit an electronic message assigning the claim to one of the shops. The agent may also interact with the reporting engine (or the insurance engine) to analyze statistics of each shop prior to making the assignment decision. For example, the insurance agent may wish to know what the level of compliance with the insurance company procedures is, what the available capacity is at each of the shops and what the on-time delivery rates are. Based on this type of information, the agent may make a more informed assignment decision based on up to date information. Alternatively, the agent may go through the above procedure to reduce the list of shops to a short list of good choices. The agent may then convey the short list to the car owner. The car owner may then: contact an employee at insurance company with her selection; contact one of the shops on the list which may affect the assignment using the platform; or transmit an electronic message to the platform (upon being given access) or otherwise contact the platform provider to affect the appropriate assignment of the claim.

### Example 2—The platform Makes the Assignment

An insurance agent receives notice of a claim under an automobile insurance policy as a result of an automobile accident. The accident occurred in Santa Monica, Calif. The insurance agent logs onto the platform and interacts with the insurance engine to provide: the location of the damaged automobile or the car owner as an address in Santa Monica; the name of the insurance company that issued the policy; and optionally, for example, a 30 mile maximum distance that a shop may be from the car owner or location of the damaged vehicle that is acceptable. In response, the insurance claim processing engine 810 queries the database 750. Based on the insurance company requirements, shop specific statistics and shop specific repair order data, the database automatically assigns the claim to a shop which meets the insurance company requirements within a 30 mile radius of the address in Santa Monica and which has capacity available to handle the assignment in the appropriate time frame. The latter decision may be made based on up-to-date scheduling information for each qualifying shop.

In step 915, the insurance claim processing engine 810 receives the assignment of a shop to the insurance claim (or makes the assignment as in example 2). In step 920, the insurance claim processor 810 sends an electronic message to the mailbox of the assigned shop via the message engine 820. The electronic message may include the claim data. The insurance claim processor 810 may also send an electronic message identifying the assigned shop to the mailbox (or e-mail address) of the insurance agent or the customer if the customer has become a recognized user of the platform.

In step 925, the shop repair processes begin as shown in FIG. 1 and the shop may contact the customer to schedule and then perform the repair. In step 930, the assigned shop performing the repair synchronizes its database with the platform database 750. The synchronizing may be performed under control of the database 750, the remotely hosted scheduling engine 800 or any other convenient process within the platform 705 at various time intervals. Alternatively, the synchronizing may be event driven or a combination of event driven and time interval driven. In this manner, as shops set up and schedule repair orders, assign and complete repair tasks, this information is made available to the fields 755, 760 and 770 in the database 750 of the platform. The synchronization step 930 may be initiated at any time by the platform database 705 or by the shop scheduling hub 245. In step 935, the platform 705 provides claim processing information to requesters. The claim processing information may be provided in the form of messages automatically generated by the message engine 820 or in response to platform user requests via the messaging engine. Steps 930 and 935 may be viewed as on-going and not occurring in any particular order relative to other steps.

In step 940, electronic messages are exchanged between the shop, the insurance agent and optionally the customer in response to actions taken by the shop or the insurance agent. For example the shop may perform an estimate and take digital photographs of the damage. The shop may then send the estimate and accompanying digital photographs to the mailbox of the insurance agent (and optionally the customer) via the message engine 820. The insurance agent may change the estimate or otherwise send electronic messages back to the shop adjusting the estimate or disagreeing with it. The shop may also change or supplement the estimate and transmit such changes or supplements to the mailbox of the insurance agent and/or customer. The customer may approve the estimate by sending an electronic message to the shop and/or the insurance agent using the message engine. Alternatively, the customer may be required to sign a hard copy of the estimate.

In step 945, the platform sends electronic messages via the messaging engine 945 notifying parties, including the insurance agent and the customer, that repairs have been completed. Then in step 950, the platform may process post repair activities including sending follow-up electronic messages to the customer or to a CSI service via the message engine 820. The platform may also convey CSI results between the CSI service and the insurance agent.

FIG. 10 depicts a method of providing collected repair order data to those to whom it has economic or other value. Referring to FIG. 10, in step 1000 the platform 705 maintains up to date statistics, historical repair order data and current repair order data. This occurs through the on-going database synchronization processes described with respect to the databases 750 and 250 and steps 930 and 935.

In step 1010, the platform receives a request for a report based on the statistics, the repair order data or the historical repair order data. Then in step 1020, the reporting engine 840 queries the database based on the parameters included in the request. Then in step 1030, the resulting information is transmitted as a report through an electronic message delivered to a mailbox of the requester.

The reports may be requested for various reasons and to affect change in organizations. For example, reports may be requested by insurance companies to determine which shops to include in a preferred network, to determine what to charge for insurance premiums, to define different levels of service based on whether a customer goes “in-network” or “out-of-network” for repairs and to perform monitoring functions using current, comprehensive and accurate information.

The reports may be designed to elicit data used to monitor the automobile repair industry as a whole to identify trends, problems and opportunities. Reports may be designed and used by rental car companies, for example, to determine areas of high demand for rental cars in real, or near-real, time and accordingly optimize fleet deployment. Reports also may be used by government agencies and automobile manufacturers to monitor raw repair data for trends.

FIG. 11 depicts a method of configuring the platform. In step 1100, the new entities and users are identified to the platform and message engine. This step may involve a repair shop, insurance agent or customer contacting an employee at the platform to register as a user of the platform. In the case of shops, the process may include identifying the IP address of the shop's database or server on which repair order data is to be maintained as well as the type of software used and any other database mapping techniques that may be involved to insure proper synchronization between the shop's database and the database 750. The information collected may further include the name, address and phone number of the shop, an email address that is to be used for the shop and the userid and password for each user at the shop who will have access to the platform. The information from insurance companies, agents, shops and customers may be connected automatically based on online registration. For example, insurance companies, agents, shops and customers may be prompted to complete on-line forms through which this information is collected.

In step 1110, the user administration engine optionally receives requirement data (such as DRP procedures and associated acceptable compliance levels) from insurance companies and stores them in the database.

In step 1120, the user administration engine optionally collects billing information from entities to be used in billing for services as appropriate. Then in step 1130, the user administration engine configures the database 750 and platform server 740 based on the collected information to set up mailboxes (or off-platform e-mail mailboxes), billing information, insurance company requirements, shop specific statistics, synchronization procedures and other information as required for the recognized entities and users.

The terminals 215 and 220, the systems 220-240, the hub 245, the platform server 740, the terminals 715 and 720, and the systems 730-735 may each be implemented as a general purpose computer system. The general purpose computer system may include an input/output unit which may collectively comprise a display, a printer, speakers, a keyboard, a mouse or other pointing device, a speech or handwriting recognition device and any other input/output devices. The general purpose computer system may further include a modem for connection to the network 210 or 710, a memory for storing program instructions and data received from the communication network 210 and a processor, coupled to the memory, input/output unit and the modem, for executing the program instructions. Each of the methods depicted in FIGS. 1, 4, 6, 9, 10 and 11 and the methods and software components described in the text may be implemented in software as program instructions executed by the processor of a general purpose computer system. The program instructions corresponding to the methods disclosed herein may be stored within a computer usable medium, such as a hard or floppy disk, a compact disc (CD) read only memory (ROM), a ROM, a file sent over a network or other vehicle for storing and/or delivering information to a computer. The program instructions corresponding to methods disclosed herein may be uploaded to the memory by devices corresponding to the medium, such as hard disc drives, and the program instructions may be executed by the processor of a general purpose computer to cause the computer to execute the steps shown and described.

It will further be understood that any or all of the terminals 215 and 220, the systems 220-240, the hub 245, the platform server 740, the terminals 715 and 720 and the systems 730-735 may each be implemented as a hand-held device, such as a device that is optically or wirelessly connected to the network 210 or 710 and otherwise operates in accordance with the same principles as a general purpose computer system as described above. It will further be understood that the systems and methods may be implemented on a single, stand alone computer system which may or may not be connected to a network and which utilizes local memory to store the contents of the database 250 and local input/output unit(s) to communicate tasks to shop personnel.

While specific embodiments of the invention have been disclosed, it will be understood that that changes may be made to those embodiments without departing from the spirit and scope of the invention.

What is claimed is:

1. A method of coordinating automobile repairs, comprising:
maintaining in a first database shop specific statistics for a plurality of body shops, the shop specific statistics being automatically updated based on data received over a network from computers;
receiving insurance claim data for an insurance claim relating to the repair of an automobile;
processing the insurance claim based on the shop specific statistics and the insurance claim data.

2. The method according to claim 1, wherein the shop specific statistics include at least one of:
available capacity, customer satisfaction index, cycle time, customer call performance, on-time delivery, employee satisfaction, throughput, dead time, labor utilization, asset utilization and labor productivity.

3. The method according to claim 1, wherein the shop specific statistics include on-time delivery.

4. The method according to claim 1, wherein the shop specific statistics include available capacity.

5. The method according to claim 1, wherein the shop specific statistics include cycle-time.

6. The method according to claim 1, wherein the processing includes:
transmitting at least a portion of the shop specific statistics for at least one shop to an insurance agent computer.

7. The method according to claim 6, wherein the agent computer is operated by an insurance company.

8. The method according to claim 6, wherein the agent computer is operated by an automobile consolidator.

9. The method according to claim 6, wherein the agent computer is operated by an automobile repair chain.

10. The method according to claim 6, wherein the agent computer is operated by an insurance intermediary.

11. The method according to claim 6, wherein the processing further comprises:
receiving an assignment of a new insurance claim from the agent computer; and
transmitting an electronic message assigning the new insurance claim to one of the shops based on the assignment.

12. The method according to claim 1, wherein the processing includes:
receiving geographic information associated with a new insurance claim from an insurance agent computer;
querying the database to select shops within a predetermined geographic area based on the geographic information; and
transmitting a list of selected shops and at least a portion of the shop specific statistics associated with each of the shops on the list to the agent computer.

13. The method according to claim 12, wherein the processing further comprises:
receiving an assignment of the new insurance claim from the agent computer; and
transmitting an electronic message assigning the new insurance claim to one of the shops based on the assignment.

14. The method according to claim 1, wherein the processing includes:
automatically assigning a new insurance claim to one of the body shops based on the claim data associated with the new insurance claim and the statistics; and
transmitting an electronic message assigning the new insurance claim to the assigned shop.

15. The method according to claim 1, further comprising maintaining insurance company requirement data for each of a plurality of insurance companies in a second database.

16. The method according to claim 15, wherein the first and second databases are parts the same database.

17. The method according to claim 15, wherein the processing includes:
automatically assigning a new insurance claim to one of the body shops based on the claim data associated with the new insurance claim, the statistics and the insurance company requirement data; and
transmitting an electronic message assigning the new insurance claim to the assigned shop.

18. The method according to claim 1, wherein the automatic updating of the first database is performed in response to an event being registered at a body shop computer.

19. The method according to claim 1, wherein the automatic updating of the first database is performed at periodic intervals based on interaction with databases at each of the body shops.

20. The method according to claim 1, wherein the automatic updating of the first database is performed at periodic intervals.

21. The method according to claim 1, further comprising:
maintaining in the first database automobile specific repair data, the automobile specific repair data being determined based on repair task data associated with individual automobile repair orders at each of the plurality of individual body shops.

22. The method according to claim 21, wherein the automobile specific repair data includes associated insurance claim numbers for each of a plurality of insurance providers.

23. The method according to claim 21, further comprising:
receiving an electronic message from a computer including a claim number and a request for status of the corresponding automobile undergoing repair;
determining status information based on the claim number and the automobile specific repair data within the first database; and
transmitting an electronic message to the computer with determined status information.

24. The method according to claim 21, further comprising:
creating repair task data for each automobile repair order in response to the assignment of a new claim to the assigned shop, the repair task data including a plurality of tasks and a corresponding resource required for the performance of each of task;
continuously scheduling the tasks associated with the repair task data for all of the claims assigned to the assigned shop among the available resources of the assigned shop;
receiving updates to the repair task data from computers of the assigned shop in response to completion of tasks; and
updating the first database based on the updated repair task data.

25. The method according to claim 21, further comprising:
automatically updating the shop specific statistics based on the automobile specific repair data for each of the plurality of shops.

26. A method of maintaining and providing automobile repair data, comprising:
maintaining in a database statistics for a plurality of body shops, the shop specific statistics being automatically updated based on data received from computers over a network;
receiving a request for information from the database; and
transmitting a response based on the statistics.

27. The method according to claim 26, wherein the automatic updating of the shop specific statistics is further performed based on repair data associated with individual automobile repair orders at each of the plurality of individual body shops.

28. The method according to claim 27, wherein the request for information is a request for status of an individual automobile repair.

29. The method according to claim 27, wherein the request for information is a request for statistics of an individual automobile repair shop.

30. The method according to claim 27, wherein the request for information is a request for identification of all automobile repair shops having statistics that meet a predetermined criteria.

31. The method according to claim 30, wherein the predetermined criteria include geographic area criteria.

32. The method according to claim 27, wherein the response is used to monitor an individual body shop's performance.

33. The method according to claim 32, wherein the performance includes at least one of floor operational performance, return on investment, return on assets, billing performance, hiring performance and employee performance.

34. The method according to claim 27, wherein the response is used to monitor the progress of an individual automobile repair.

35. The method according to claim 27, wherein the response is used to determine root cause of delay.

36. The method according to claim 27, wherein the response is used to determine insurance pricing.

37. The method according to claim 27, wherein the response is used to optimize ordering supplies for a shop.

38. The method according to claim 27, wherein the response is used to optimize rental car fleet deployment.

39. The method according to claim 27, wherein the response is used to monitor the statistics for trends in automobile repair.

40. The method according to claim 39, wherein the trends include data on failure of individual parts.

41. A method of maintaining automobile repair data and automatically notifying interested parties of events, comprising:
maintaining in a database shop specific statistics for a plurality of body shops, the shop specific statistics being automatically updated based on events associated with individual automobile repair orders at each of a plurality of individual body shops; and
automatically generating notifications based on the statistics; and
transmitting the notifications to respective interested parties.

42. The method according to claim 41, wherein one of the events is the passing of a deadline for repairing an automobile and the notification is an electronic message indicating that the automobile repair will be late.

43. The method according to claim 41, wherein the notification is an electronic message indicating that a shop specific statistic has fallen outside of a predetermined range.

44. The method according to claim 41, wherein the notification is an electronic message to a car rental agency that a rental car is required in connection with an individual automobile repair.

45. A platform for managing insurance claims, comprising:
an input/output unit disposed in communication with insurance company computers and repair shop computers via a communications network;
a memory for storing program instructions, the memory including a database for storing shop specific statistics for a plurality of body shops, the shop specific statistics being updated based on data received from computers over the network; and
a processor disposed in communication with the communications network and the memory, the processor executing the program instructions to: a) automatically update the statistics in the database based on data received from the shop computers, b) receive insurance claims from insurance company computers, each insurance claim including claim data relating to the repair of an automobile, and c) process the insurance claims.

46. The platform according to claim 45, wherein the shop specific statistics include at least one of:
available capacity, customer satisfaction index, cycle time, customer call performance, on-time delivery, employee satisfaction, throughput, dead time, labor utilization, asset utilization and labor productivity.

47. The platform according to claim 45, wherein the shop specific statistics include on-time delivery.

48. The platform according to claim 45, wherein the shop specific statistics include available capacity.

49. The platform according to claim 45, wherein the shop specific statistics include cycle-time.

50. The platform according to claim 45, wherein the processor further transmits at least a portion of the shop specific statistics for at least one shop to an insurance agent computer.

51. The platform according to claim 50, wherein the agent computer is operated by an insurance company.

52. The platform according to claim 50, wherein the agent computer is operated by an automobile consolidator.

53. The platform according to claim 50, wherein the agent computer is operated by an automobile repair chain.

54. The platform according to claim 50, wherein the agent computer is operated by an insurance intermediary.

55. The platform according to claim 50, wherein the processor further:
receives an assignment of a new insurance claim from the agent computer; and
transmits an electronic message assigning the new insurance claim to one of the shops based on the assignment.

56. The platform according to claim 45, wherein the processor further:
receives geographic information associated with a new insurance claim from an insurance agent computer;
queries the database to select shops within a predetermined geographic area based on the geographic information; and
transmits a list of selected shops and at least a portion of the shop specific statistics associated with each of the shops on the list to the agent computer.

57. The platform according to claim 56, wherein the processing further comprises:
receiving an assignment of the new insurance claim from the agent computer; and
transmitting an electronic message assigning the new insurance claim to one of the shops based on the assignment.

58. The platform according to claim 45, wherein the processor further:
automatically assigns a new insurance claim to one of the body shops based on the claim data associated with the new insurance claim and the statistics; and
transmits an electronic message assigning the new insurance claim to the assigned shop.

59. The platform according to claim 45, further comprising maintaining insurance company requirement data for each of a plurality of insurance companies in a second database.

60. The platform according to claim 59, wherein the first and second databases are parts the same database.

61. The platform according to claim 59, wherein the processor further:
automatically assigns a new insurance claim to one of the body shops based on the claim data associated with the new insurance claim, the statistics and the insurance company requirement data; and
transmits an electronic message assigning the new insurance claim to the assigned shop.

62. The platform according to claim 45, wherein the processor automatically updates the first database in response to an event being registered at a body shop computer.

63. The platform according to claim 45, wherein the processor automatically updates the first database at periodic intervals based on interaction with databases at each of the body shops.

64. The platform according to claim 45, wherein the processor automatically updates the first database at periodic intervals.

65. The platform according to claim 45, wherein the processor further:
maintains in the first database automobile specific repair data, the automobile specific repair data being determined based on repair task data associated with individual automobile repair orders at each of the plurality of individual body shops.

66. The platform according to claim 65, wherein the automobile specific repair data includes associated insurance claim numbers for each of a plurality of insurance providers.

67. The platform according to claim 65, wherein the processor further:
receives an electronic message from a computer including a claim number and a request for status of the corresponding automobile undergoing repair;
determines status information based on the claim number and the automobile specific repair data within the first database; and
transmits an electronic message to the computer with determined status information.

68. The platform according to claim 65, wherein the processor further:
creates repair task data for each automobile repair order in response to the assignment of a new claim to the assigned shop, the repair task data including a plurality of tasks and a corresponding resource required for the performance of each of task;
continuously schedules the tasks associated with the repair task data for all of the claims assigned to the assigned shop among the available resources of the assigned shop; and
receives updates to the repair task data from computers of the assigned shop in response to completion of tasks; and
updates the first database based on the updated repair task data.

69. The platform according to claim 45, wherein the processor further:
automatically updates the shop specific statistics based on the automobile specific repair data for each of the plurality of shops.

70. A platform for maintaining and providing automobile repair data, comprising:
an input/output unit disposed in communication with a communications network;
a memory for storing program instructions, the memory including a database for storing shop specific statistics for a plurality of body shops, the shop specific statistics being updated based on data received from computers over the network; and
a processor disposed in communication with the communications network and the memory, the processor executing the program instructions to: a) automatically update the statistics in the database based on data received from computers over the network, b) receive a request for information from the database, and c) transmit a response based on the statistics.

71. The platform according to claim 70, wherein the processor automatically updates the shop specific statistics based on repair data associated with individual automobile repair orders at each of the plurality of individual body shops.

72. The platform according to claim 71, wherein the request for information is a request for status of an individual automobile repair.

73. The platform according to claim 71, wherein the request for information is a request for statistics of an individual automobile repair shop.

74. The platform according to claim 71, wherein the request for information is a request for identification of all automobile repair shops having statistics that meet a predetermined criteria.

75. The platform according to claim 74, wherein the predetermined criteria include geographic area criteria.

76. The platform according to claim 71, wherein the response is used to monitor an individual body shop's performance.

77. The platform according to claim 76, wherein the performance includes at least one of floor operational performance, return on investment, return on assets, billing performance, hiring performance and employee performance.

78. The platform according to claim 71, wherein the response is used to monitor the progress of an individual automobile repair.

79. The platform according to claim 71, wherein the response is used to determine root cause of delay.

80. The platform according to claim 71, wherein the response is used to determine insurance pricing.

81. The platform according to claim 71, wherein the response is used to optimize rental car fleet deployment.

82. The platform according to claim 71, wherein the response is used to optimize ordering supplies for a shop.

83. The platform according to claim 71, wherein the response is used to monitor the statistics for trends in automobile repair.

84. The platform according to claim 82, wherein the trends include data on failure of individual parts.

85. A platform for maintaining automobile repair data and automatically notifying interested parties of events, comprising:
an input/output unit disposed in communication with a communications network;
a memory for storing program instructions, the memory including a database for storing shop specific statistics for a plurality of body shops, the shop specific statistics being automatically updated based on events associated with individual automobile repair orders at each of a plurality of individual body shops; and
a processor disposed in communication with the communications network and the memory, the processor executing the program instructions to: a) automatically update the statistics in the database based on the events received from the network; b) automatically generate notifications based on the statistics, and c) transmit the notifications to respective interested parties.

86. The platform according to claim 85, wherein one of the events is the passing of a deadline for repairing an automobile and the notification is an electronic message indicating that the automobile repair will be late.

87. The platform according to claim 85, wherein the notification is an electronic message indicating that a shop specific statistic has fallen outside of a predetermined range.

88. The method according to claim 85, wherein the notification is an electronic message to a car rental agency that a rental car is required in connection with an individual automobile repair.

89. A computer program product for coordinating automobile repairs, the computer program product comprising a computer useable medium having computer program logic therein, the computer program logic including:
maintaining means for causing the computer to maintain in a first database shop specific statistics for a plurality of body shops, the shop specific statistics being automatically updated based on data received over a network from computers;
receiving means for causing the computer to receive insurance claim data for an insurance claim relating to the repair of an automobile;
processing means for causing the computer to process the insurance claim based on the shop specific statistics and the insurance claim data.

90. The computer program product according to claim 89, wherein the shop specific statistics include at least one of:
available capacity, customer satisfaction index, cycle time, customer call performance, on-time delivery, employee satisfaction, throughput, dead time, labor utilization, asset utilization and labor productivity.

91. The computer program product according to claim 89, wherein the shop specific statistics include on-time delivery.

92. The computer program product according to claim 89, wherein the shop specific statistics include available capacity.

93. The computer program product according to claim 89, wherein the shop specific statistics include cycle-time.

94. The computer program product according to claim 89, wherein the processing means includes means for causing the computer to transmit at least a portion of the shop specific statistics for at least one shop to an insurance agent computer.

95. The computer program product according to claim 94, wherein the agent computer is operated by an insurance company.

96. The computer program product according to claim 94, wherein the agent computer is operated by an automobile consolidator.

97. The computer program product according to claim 94, wherein the agent computer is operated by an automobile repair chain.

98. The computer program product according to claim 94, wherein the agent computer is operated by an insurance intermediary.

99. The computer program product according to claim 94, wherein the processing means further comprises:
receiving means for causing the computer to receive an assignment of a new insurance claim from the agent computer; and
transmitting means for causing the computer to transmit an electronic message assigning the new insurance claim to one of the shops based on the assignment.

100. The computer program product according to claim 89, wherein the processing means includes:
receiving means for causing the computer to receive geographic information associated with a new insurance claim from an insurance agent computer;
querying means for causing the computer to query the database to select shops within a predetermined geographic area based on the geographic information; and
transmitting means for causing the computer to transmit a list of selected shops and at least a portion of the shop specific statistics associated with each of the shops on the list to the agent computer.

101. The computer program product according to claim 100, wherein the processing means further comprises:
receiving means for causing the computer to receive an assignment of the new insurance claim from the agent computer; and
transmitting means for causing the computer to transmit an electronic message assigning the new insurance claim to one of the shops based on the assignment.

102. The computer program product according to claim 89, wherein the processing means includes:
assigning means for causing the computer to automatically assign a new insurance claim to one of the body shops based on the claim data associated with the new insurance claim and the statistics; and
transmitting means for causing the computer to transmit an electronic message assigning the new insurance claim to the assigned shop.

103. The computer program product according to claim 89, further comprising:
maintaining means for causing the computer to maintain insurance company requirement data for each of a plurality of insurance companies in a second database.

104. The computer program product according to claim 103, wherein the first and second databases are parts the same database.

105. The computer program product according to claim 103, wherein the processing means includes:
assigning means for causing the computer to automatically assign a new insurance claim to one of the body shops based on the claim data associated with the new insurance claim, the statistics and the insurance company requirement data; and
transmitting means for causing the computer to transmit an electronic message assigning the new insurance claim to the assigned shop.

106. The computer program product according to claim 89, wherein the automatic updating of the first database is performed in response to an event being registered at a body shop computer.

107. The computer program product according to claim 89, wherein the automatic updating of the first database is performed at periodic intervals based on interaction with databases at each of the body shops.

108. The computer program product according to claim 89, wherein the automatic updating of the first database is performed at periodic intervals.

109. The computer program product according to claim 89, further comprising:
maintaining means for causing the computer to maintain in the first database automobile specific repair data, the automobile specific repair data being determined based on repair task data associated with individual automobile repair orders at each of the plurality of individual body shops.

110. The computer program product according to claim 109, wherein the automobile specific repair data includes associated insurance claim numbers for each of a plurality of insurance providers.

111. The computer program product according to claim 109, wherein the processing means further comprises:
receiving means for causing a computer to receive an electronic message from a computer including a claim number and a request for status of the corresponding automobile undergoing repair;
determining means for causing a computer to determine status information based on the claim number and the automobile specific repair data within the first database; and
transmitting means for causing a computer to transmit an electronic message to the computer with determined status information.

112. The computer program product according to claim 109, further comprising:
creating means for causing the computer to create repair task data for each automobile repair order in response to the assignment of a new claim to the assigned shop, the repair task data including a plurality of tasks and a corresponding resource required for the performance of each of task;
scheduling means for causing the computer to continuously schedule the tasks associated with the repair task data for all of the claims assigned to the assigned shop among the available resources of the assigned shop;
receiving means for causing the computer to receive updates to the repair task data from computers of the assigned shop in response to completion of tasks; and
updating means for causing the computer to update the first database based on the updated repair task data.

113. The computer program product according to claim 109, further comprising:
automatically updating the shop specific statistics based on the automobile specific repair data for each of the plurality of shops.

114. A computer program product for maintaining and providing automobile repair data, the computer program product comprising a computer useable medium having computer program logic therein, the computer program logic including:
maintaining means for causing the computer to maintain in a database statistics for a plurality of body shops, the shop specific statistics being automatically updated based on data received from computers over a network;
receiving means for causing the computer to receive a request for information from the database; and
transmitting means for causing the computer to transmit a response based on the statistics.

115. The computer program product according to claim 114, wherein the automatic updating of the shop specific statistics is further performed based on repair data associated with individual automobile repair orders at each of the plurality of individual body shops.

116. The computer program product according to claim 115, wherein the request for information is a request for status of an individual automobile repair.

117. The computer program product according to claim 115, wherein the request for information is a request for statistics of an individual automobile repair shop.

118. The computer program product according to claim 115, wherein the request for information is a request for identification of all automobile repair shops having statistics that meet a predetermined criteria.

119. The computer program product according to claim 118, wherein the predetermined criteria include geographic area criteria.

120. The computer program product according to claim 115, wherein the response is used to monitor an individual body shop's performance.

121. The computer program product according to claim 120, wherein the performance includes at least one of floor operational performance, return on investment, return on assets, billing performance, hiring performance and employee performance.

122. The computer program product according to claim 115, wherein the response is used to monitor the progress of an individual automobile repair.

123. The computer program product according to claim 115, wherein the response is used to determine root cause of delay.

124. The computer program product according to claim 115, wherein the response is used to determine insurance pricing.

125. The computer program product according to claim 115, wherein the response is used to optimize rental car fleet deployment.

126. The computer program product according to claim 115, wherein the response is used to optimize ordering supplies.

127. The computer program product according to claim 115, wherein the response is used to monitor the statistics for trends in automobile repair.

128. The computer program product according to claim 127, wherein the trends include data on failure of individual parts.

129. A computer program product for maintaining automobile repair data and automatically notifying interested parties of events, the computer program product comprising a computer useable medium having computer program logic therein, the computer program logic including:
maintaining means for causing the computer to maintain in a database shop specific statistics for a plurality of body shops, the shop specific statistics being automatically updated based on events associated with individual automobile repair orders at each of a plurality of individual body shops;
generating means for causing the computer to automatically generate notifications based on the statistics; and
transmitting means for causing the computer to transmit the notifications to respective interested parties.

130. The computer program product according to claim 129, wherein one of the events is the passing of a deadline for repairing an automobile and the notification is an electronic message indicating that the automobile repair will be late.

131. The computer program product according to claim 129, wherein the notification is an electronic message indicating that a shop specific statistic has fallen outside of a predetermined range.

132. The computer program product according to claim 129, wherein the notification is an electronic message to a car rental agency that a rental car is required in connection with an individual automobile repair.
